(19) United States
(12) Patent Application Publication
(10) Pub. No.: US 2023/0048319 A1
(43) Pub. Date: Feb. 16, 2023

(54) ROTATING DEVICE AND VACUUM PUMP

(71) Applicant: Edwards Japan Limited, Yachiyo-shi, Chiba (JP)

(72) Inventors: Takaaki Ono, Yachiyo-shi, Chiba (JP); Manabu Nonaka, Yachiyo-shi, Chiba (JP)

(21) Appl. No.: 17/793,003

(22) PCT Filed: Jan. 20, 2021
(86) PCT No.: PCT/JP2021/001915

§ 371 Date: Jul. 14, 2022

(30) Foreign Application Priority Data
Jan. 23, 2020 (JP) 2020-009524

(51) Int. Cl. F04D 29/58; F04D 19/04; F04D 25/06; F04D 29/053

(52) U.S. Cl. CPC F04D 29/5846; F04D 19/042; F04D 29/5853; F04D 25/06; F04D 29/5806; F04D 29/053; F28D 15/0233

(57) ABSTRACT

A rotating device and a vacuum pump are provided, having a structure in which a refrigerant or the like does not leak out to an inside and which can sufficiently cool a rotating body, obtain high reliability, and realize cost reduction. The structure is constituted to include: a casing; a rotating body including a rotating shaft disposed rotatably relative to the casing, the rotating body constituted integrally with the rotating shaft; a hollow part formed along a center of the rotating shaft in the rotating body; and a cooling rod which is fixed to the casing and provided in a state of non-contact with the rotating body in the hollow part without having a mechanism for injecting a refrigerant, and which absorbs a radiation heat of the rotating body to cool the rotating body.

This application is a U.S. national phase application under 35 U.S.C. § 371 of international application number PCT/JP2021/001915 filed on Jan. 20, 2021, which claims the benefit of JP application number 2020-009524 filed on Jan. 23, 2020. The entire contents of each of international application number PCT/JP2021/001915 and JP application number 2020-009524 are incorporated herein by reference.

### TECHNICAL FIELD

The present disclosure relates to a rotating device and a vacuum pump and particularly to a rotating device and a vacuum pump used as a gas exhausting means or the like of a process chamber and other sealed chambers in a semiconductor manufacturing device, a flat-panel display manufacturing device, and a solar panel manufacturing device.

### BACKGROUND

In general, a built-in type rotating device incorporating a motor as power in a housing becomes a high temperature due to heat generation of the motor itself, which causes a concern that an output of the motor is lowered. In order to improve it, such a structure has been conventionally proposed that a hollow part is formed in a spindle with a rotor constituting the motor together with a stator provided, and a refrigerant (a cooling gas or a liquid) is supplied into the hollow part so as to cool the spindle and to cool the entire motor through the spindle (see Japanese Patent No. 3197195, for example).

### SUMMARY

In the structure described in Japanese Patent No. 3197195, the hollow part which is open on a base end side and is closed on a distal end side is provided on the spindle along an axis thereof, and a cooling-liquid guide is inserted/provided in the hollow part from an open part. And a cooling liquid is injected into the hollow part from a distal end of the cooling-liquid guide so as to cool the spindle so that the entire motor is cooled through the spindle.

However, the structure described in Japanese Patent No. 3197195 is constituted such that the cooling liquid (refrigerant) is injected into the hollow part from the distal end of the cooling-liquid guide and thus, there is a concern that the injected refrigerant leaks out of the hollow part into an airgap. This problem also occurs similarly when the refrigerant is a gas.

If the refrigerant leaks out into the airgap, a failure of the rotating device could occur, which is caused by erosion, insulation breakdown or the like of a material by the leaking-out refrigerant. Moreover, in the vacuum pump, if the refrigerant leaks out into the airgap, a degree of vacuum deteriorates. However, if the refrigerant with a small flowrate/pressure to such a degree that would not leak out to the airgap side is injected into the hollow part, a cooling effect is weak, and sufficient cooling cannot be obtained.

In order to prevent the refrigerant from leaking out into the airgap, a seal structure needs to be applied to an outer side of the spindle. However, if a sufficient seal structure is applied, a cost is increased. Moreover, in the rotating device such as a vacuum pump or the like in which the spindle is magnetically floated, there has been a problem that the seal structure is particularly difficult.

Thus, there is a technical problem which should be solved in order to provide a rotating device and a vacuum pump which can obtain high reliability by sufficiently cooling the rotating body with a structure in which the refrigerant does not leak out into the inside and can lower the cost, and the present disclosure has an object to solve this problem.

The present disclosure was proposed in order to achieve the aforementioned object, and a disclosure described in claim 1 provides a rotating device including a casing and a rotating body having a rotating shaft disposed rotatably relative to the casing and constituted integrally with the rotating shaft, the rotating device including:

a hollow part formed along a center of the rotating shaft inside the rotating body, and

a cooling rod which is fixed to the casing, is provided in the hollow part in a state of non-contact with the rotating body without having a mechanism for injecting a refrigerant into the hollow part, absorbs a radiation heat of the rotating body, and cools the rotating body.

According to this constitution, by means of the cooling rod provided in the hollow part formed inside the rotating body in the state of non-contact with the rotating body without having the mechanism for injecting the refrigerant into the hollow part, cooling can be performed so that the temperature of the rotating body does not become higher than necessary by absorbing the radiation heat from the rotating body.

Moreover, since the structure is not to inject the refrigerant into the hollow part, there is no need to apply a seal structure which prevents leakage of the refrigerant between a stator body and a rotating body or between the cooling rod and the rotating body, which enables size reduction and cost down.

Furthermore, since the structure is not to inject the refrigerant into the hollow part, there is no refrigerant which intrudes into the airgap, and a failure of the rotating device caused by erosion, insulation breakdown or the like of the material by the refrigerant can be prevented. Particularly, in the vacuum pump, the rotating body can be cooled without lowering the degree of vacuum, and the vacuum pump can be driven with high accuracy. Note that the spindle described in the aforementioned Japanese Patent No. 3197195 corresponds to the rotating shaft in the present disclosure.

The disclosure as described in claim 2 provides, in the constitution described in claim 1, a rotating device integrally connected to the casing through a first insulating material which shuts off the heat from the casing.

According to this constitution, since the cooling rod is integrally connected to the casing, the connection between the cooling rod and the casing is made tight, whereby high airtightness can be realized by eliminating a gap. Moreover, since the cooling rod and the casing are connected through the insulating material, the cooling rod is hardly heated by the casing, and an effect of cooling the rotating body can be improved.

The disclosure as described in claim 3 provides, in the constitution described in claim 1 or 2, a rotating device in which the cooling rod has a heat radiation mechanism which radiates a heat of the cooling rod mounted on one end side withdrawn from the hollow part.

According to this constitution, the heat of the cooling rod warmed by absorbing the radiation heat from the rotating body is emitted to the outside and escapes through the heat radiation mechanism mounted on the one end side of the cooling rod withdrawn from the hollow part, and the cooling rod can be kept in a low-temperature state efficiently.

The disclosure as described in claim 4 provides, in the constitution described in claim 3, a rotating device in which the heat radiation mechanism has a heat radiation plate.

According to this constitution, the heat of the cooling rod warmed by absorbing the radiation heat from the rotating body is emitted to the outside and escapes through the heat radiation plate provided in the heat radiation mechanism mounted on the one end side of the cooling rod withdrawn from the hollow part, and the cooling rod can be kept in the low-temperature state efficiently.

The disclosure as described in claim 5 provides, in the constitution described in claim 3 or 4, a rotating device in which the heat radiation mechanism incorporates piping through which cooling water is caused to flow.

According to this constitution, the heat radiation mechanism is cooled by the piping incorporated in the heat radiation mechanism itself and the cooling water flowing through the piping, and the heat of the cooling rod warmed by absorbing the radiation heat is absorbed by the piping and the cooling water and is caused to escape to the outside, whereby the cooling rod can be kept in the low-temperature state more efficiently. As a result, the heat radiation plate or the like provided in the heat radiation mechanism can be omitted.

The disclosure as described in claim 6 provides, in the constitution described in any one of claims 2 to 4, a rotating device in which the heat radiation mechanism has a Peltier-type unit in which a Peltier element is provided.

According to this constitution, the heat radiation mechanism is cooled by the Peltier-type unit constituted by the heat radiation mechanism itself, and the heat of the cooling rod warmed by absorbing the radiation heat from the rotating body is absorbed by the Peltier-type unit and is caused to escape to the outside, whereby the cooling rod can be kept in the low-temperature state more efficiently. The Peltier-type unit, here, is a Peltier unit known as a cooling unit using the Peltier element, for example.

The disclosure as described in claim 7 provides, in the constitution described in any one of claims 1 to 6, a rotating device in which the cooling rod has a heat radiation portion disposed outside the hollow part and has a heat pipe disposed along the rotating shaft center in the hollow part.

According to this constitution, the heat of the cooling rod warmed by the radiation heat is transmitted to the outside through the heat pipe disposed inside the cooling rod and is emitted. As a result, the cooling rod can be kept in the low-temperature state efficiently.

The disclosure as described in claim 8 provides, in the constitution described in claim 7, a rotating device in which the heat pipes are provided in plural, and a high-temperature portion of at least one of the heat pipes is disposed by being shifted in a rotating-shaft direction.

According to this constitution, by providing the high-temperature portion of at least one of the plurality of heat pipes by being shifted in the rotating-shaft direction so that the heat pipe corresponds to a part where the radiation heat is to be absorbed more, respectively, the radiation heat can be absorbed efficiently, and the rotating body can be cooled. Note that, in the rotating-shaft direction, a plurality of heat pipes with different lengths may be prepared.

The disclosure as described in claim 9 provides, in the constitution described in claim 7 or 8, a rotating device in which substantially entirety of the cooling rod is constituted by the heat pipe.

According to this constitution, by replacing the cooling rod itself with the heat pipe, the structure is simplified. And the radiation heat is directly absorbed by the heat pipe, is transmitted to the outside, and is emitted. As a result, the rotating body can be kept in the low-temperature state at all time.

The disclosure as described in claim 10 provides, in the constitution described in any one of claims 1 to 8, a rotating device in which the cooling rod is disposed along the rotating shaft center and has a refrigerant pipe through which a refrigerant is caused to flow.

According to this constitution, the heat of the cooling rod warmed by the radiation heat is emitted to the outside through the refrigerant flowing inside the cooling pipe disposed inside the cooling rod. As a result, the cooling rod can be kept in the low-temperature state at all time without allowing the refrigerant to intrude into the airgap.

The disclosure as described in claim 11 provides, in the constitution described in any one of claims 1 to 10, a rotating device in which a purge gas is caused to flow through a gap between the cooling rod and the hollow part.

According to this constitution, the cooling rod cools the rotating body by absorbing a heat transmitted by the purge gas in addition to the radiation heat directly received from the rotating body. That is, the cooling of the rotating body can be performed effectively by heat absorption of both the heat absorption by the cooling rod and the heat absorption by the purge gas.

The disclosure as described in claim 12 provides, in the constitution described in claim 11, a rotating device in which the cooling rod includes a fin in contact with the purge gas on an outer peripheral surface.

According to this constitution, the cooling effect on the rotating body can be improved by agitating the purge gas passing through the gap between the cooling rod and the hollow part by the fin provided on the outer peripheral surface of the cooling rod so as to promote heat transmission by the purge gas.

The disclosure as described in claim 13 provides, in the constitution described in claim 11 or 12, a rotating device in which a groove through which the purge gas is passed is provided in an inner peripheral surface of the hollow part.

According to this constitution, the purge gas passing through the gap between the cooling rod and the hollow part is agitated in the groove provided in the inner peripheral surface of the hollow part so as to promote the heat transmission, whereby the cooling effect on the rotating body can be improved.

The disclosure as described in claim 14 provides, in the constitution described in any one of claims 1 to 13, a rotating device in which the cooling rod is formed with a locally increased thickness so that a surface area of a spot to be an outer peripheral surface or an inner peripheral surface of the cooling rod corresponding to a spot requiring cooling of the rotating body becomes larger than the surface area of a spot to be the outer peripheral surface or the inner peripheral surface of the cooling rod corresponding to a spot not requiring the cooling.

According to this constitution, by enlarging the surface area by increasing the thickness of the spot to be the outer peripheral surface or the inner peripheral surface of the cooling rod corresponding to the spot requiring the cooling of the rotating body, a heat transmission amount of the spot requiring the cooling is increased, and the rotating body can be cooled efficiently.

The disclosure as described in claim 15 provides, in the constitution described in any one of claims 1 to 14, a rotating device in which a spot between the cooling rod and the hollow part corresponding to the spot not requiring the cooling of the rotating body is covered by a second insulating material.

According to this constitution, heating of the cooling rod by receiving the heat from the spot not requiring the cooling is prevented by the second insulating material provided between the cooling rod and the hollow part, whereby the cooling effect on the rotating body can be improved.

The disclosure as described in claim 16 provides a vacuum pump including:

a casing in which an inlet port and an outlet port are formed,

a rotating shaft disposed rotatably relative to the casing, and

a rotating body constituted integrally with the rotating shaft,

the vacuum pump further including

inside the rotating body, a hollow part formed along the rotating shaft center, and

a cooling rod which is fixed to the casing and provided in the hollow part in a state of non-contact with the rotating body without having a mechanism for injecting a refrigerant into the hollow part, and which absorbs a radiation heat of the rotating body so as to cool the rotating body.

According to the vacuum pump according to this constitution, by means of the cooling rod provided in the state of non-contact with the rotating body in the hollow part formed inside the rotating body without having the mechanism for injecting the refrigerant into the hollow part, the radiation heat from the rotating body can be absorbed and cooled so that the temperature of the rotating body does not rise higher than necessary.

Moreover, since it is not such a structure that injects the refrigerant into the hollow part, there is no need to apply the seal structure which prevents leakage of the refrigerant between the cooling rod and the rotating body, which enables size reduction and cost down.

Furthermore, since it is not such a structure that injects the refrigerant into the hollow part, there is no refrigerant which directly intrudes to the airgap side of the motor portion or the like and the side of the rotor blade or the like. Thus, the rotating body can be cooled without lowering the degree of vacuum, and the vacuum pump can be driven with high accuracy. Moreover, since there is no refrigerant in direct contact with the rotating body or the stator body, erosion of the rotating body or the stator body can be prevented.

According to the disclosure, by means of the cooling rod provided in the state of non-contact with the rotating body in the hollow part formed inside the rotating body, the cooling can be performed so that the rotating body temperature does not become higher than necessary by absorbing the radiation heat from the rotating body. Moreover, since the refrigerant is not injected into the hollow part, there is no need to apply the seal structure which prevents leakage of the refrigerant between the cooling rod and the rotating body, which enables size reduction and cost down.

Moreover, since it is not such a structure that injects the refrigerant into the hollow part, there is no refrigerant which intrudes into the airgap, and a failure of the rotating device caused by erosion, insulation breakdown or the like of the material by the refrigerant can be prevented. When it is applied to the vacuum pump, since there is no refrigerant directly intruding to the airgap side of the motor portion or the like and the rotator blade side of the rotating body or the like, the rotating body can be cooled without lowering the degree of vacuum, and the vacuum pump can be driven with high accuracy. Furthermore, since there is no refrigerant in direct contact with the rotating body or the stator body, erosion of the rotating body or the stator body can be prevented, whereby durability can be improved.

### BRIEF DESCRIPTION OF THE DRAWINGS

FIG. 1 is a schematic vertical-section side view of a vacuum pump shown as a rotating device according to an example of the present disclosure;

FIGS. 2A and 2B are diagrams for explaining a variation of the vacuum pump shown in FIG. 1, in which FIG. 2A is a schematic vertical-section side view, and FIG. 2B is a plan view when seen from an arrow 100 direction in FIG. 2A;

FIG. 3 is a diagram for explaining another variation of the vacuum pump shown in FIG. 1 and a schematic vertical-section side view showing a structure in a periphery of a base-end lid of the vacuum pump shown in FIG. 1 in an enlarged manner;

FIGS. 4A and 4B are diagrams for explaining a variation shown in FIG. 3, in which FIG. 4A is a side view illustrating a part of a heat radiation mechanism thereof in a broken manner, and FIG. 4B is a bottom view of the heat radiation mechanism when seen from an A-A line arrow-view direction in FIG. 4A;

FIG. 5 is a diagram for explaining another variation of the heat radiation mechanism shown in FIG. 3 and is a side view of the heat radiation mechanism;

FIG. 6 is a diagram for explaining still another variation of the vacuum pump shown in FIG. 1 and is a partially enlarged view of the vacuum pump;

FIG. 7 is a diagram for explaining still another variation of the vacuum pump shown in FIG. 1 and is a partially enlarged view of the vacuum pump;

FIG. 8 is a partially enlarged view of the vacuum pump illustrated as still another variation of the vacuum pump shown in FIG. 1;

FIGS. 9A and 9B are diagrams for explaining a variation of a cooling rod in the vacuum pump shown in FIG. 8, in which FIG. 9A is a side view of the cooling rod, and FIG. 9B is a B-B line arrow-view sectional diagram of the FIG. 9A;

FIG. 10 is a diagram for explaining another variation of the cooling rod in the vacuum pump shown in FIG. 8 and is a side view of the cooling rod;

FIG. 11 is a diagram for explaining still another variation of the cooling rod in the vacuum pump shown in FIG. 8 and is a side view of the cooling rod;

FIG. 12 is a diagram for explaining a variation of the cooling rod in the vacuum pump shown in FIG. 8 and is a side view of the cooling rod;

FIG. 13 is a diagram for explaining still another variation of the vacuum pump shown in FIG. 1 and is a schematic vertical-section side view of the vacuum pump;

FIG. 14 is an enlarged view of a B-part of the vacuum pump shown in FIG. 13;

FIG. 15 is a diagram for explaining still another variation of the vacuum pump shown in FIG. 1 and is a schematic vertical-section side view of the vacuum pump;

FIG. 16 is an enlarged view of a C-part of the vacuum pump shown in FIG. 15;

FIG. 17 is a diagram for explaining still another variation of the vacuum pump shown in FIG. 1 and is a schematic vertical-section side view of the vacuum pump;

FIG. 18 is an enlarged view of a D-part of the vacuum pump shown in FIG. 17;

FIG. 19 is a schematic vertical-section side view of the vacuum pump illustrated as still another variation of the vacuum pump shown in FIG. 1;

FIG. 20 is an enlarged view of an E-part of the vacuum pump shown in FIG. 19;

FIG. 21 is a diagram for explaining still another variation of the vacuum pump shown in FIG. 1 and is a schematic vertical-section side view of the vacuum pump;

FIG. 22 is an enlarged view of an F-part of the vacuum pump shown in FIG. 21;

FIG. 23 is a diagram for explaining still another variation of the vacuum pump shown in FIG. 1 and is a schematic vertical-section side view of the vacuum pump; and

FIG. 24 is an enlarged view of a G-part of the vacuum pump shown in FIG. 23.

### DETAILED DESCRIPTION

The present disclosure describes a rotating device in order to achieve an object to provide a rotating device and the like which can obtain high reliability by sufficiently cooling a rotating body with a structure in which a refrigerant or the like does not leak out into an inside and can lower a cost, including a casing and a rotating body having a rotating shaft disposed rotatably relative to the casing and constituted integrally with the rotating shaft, and it was realized by a constitution including a hollow part formed along a center of the rotating shaft inside the rotating body and a cooling rod fixed to the casing and provided in a state of non-contact with the rotating body in the hollow part without having a mechanism for injecting a refrigerant into the hollow part and cooling the rotating body by absorbing a radiation heat of the rotating body.

Hereinafter, some examples of the present disclosure will be described in detail on the basis of the attached drawings. Note that, in the following examples, when numbers, numeral values, amounts, ranges and the like of constituent elements are referred to, except a case explicitly indicated in particular and a case in principle and apparently limited to a specific number, they are not limited to the specific numbers but may be larger or smaller than the specific numbers.

Moreover, when shapes and positional relationships of the constituent elements and the like are referred to, except a case explicitly indicated in particular and a case in principle and apparently considered not to be so and the like, they include those substantially approximating or similar to the shapes and the like.

Moreover, the drawings are exaggerated by enlarging a featured part or the like in order to facilitate understanding of the featured part in some cases, and dimension ratios and the like of the constituent elements are not necessarily identical to the actual. Furthermore, in sectional views, hatching of some of the constituent elements is omitted in order to facilitate understanding of a sectional structure of the constituent element in some cases.

Moreover, in the following explanation, expressions indicating directions such as up-down, left-right and the like are not absolute, and though they are appropriate when each part of the rotating device in the present disclosure is depicted but should be interpreted with changes in accordance with changes in an attitude when the attitude was changed. Furthermore, the same reference signs are given to the same elements throughout the explanation of the examples.

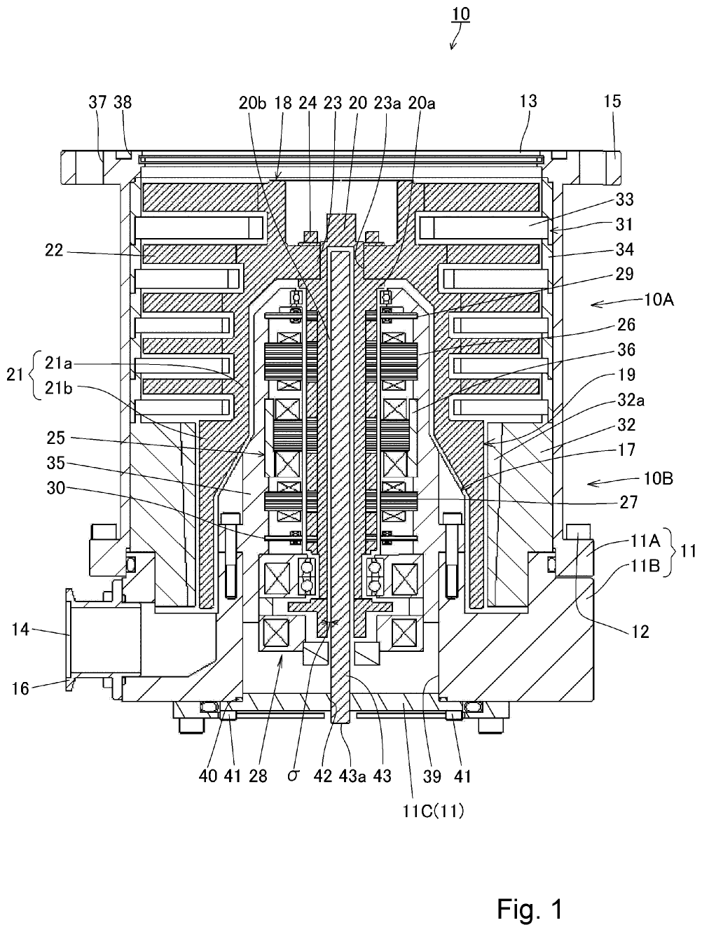

FIG. 1 shows a vacuum pump 10 as an example in the rotating device according to the present disclosure and is a schematic vertical-section side view of the vacuum pump 10. In the following explanation, an up-down direction in FIG. 1 will be described as up-down of the device.

The vacuum pump 10 shown in FIG. 1 is a complex-pump (also referred to as a “turbo-molecular pump”) including a molecular-pump mechanism portion 10A as a gas exhaustion mechanism and a thread-groove type pump mechanism portion 10B. The vacuum pump 10 is used as a gas exhausting means or the like of a process chamber and other sealed chamber in a semiconductor manufacturing device, a flat-panel display manufacturing device, and a solar-panel manufacturing device, for example.

The vacuum pump 10 includes a casing 11. The casing 11 is formed having a substantially cylindrical shape with a bottom by disposing a cylindrically-shaped pump case 11A, a pump base 11B, and a base end lid 11C in a cylinder axis direction thereof, by connecting the pump case 11A and the pump base 11B by a fastening member 12, and by connecting the pump base 11B and the base end lid 11C by a mounting bolt 41.

An upper end portion side of the pump case 11A (upward on the paper surface in FIG. 1) is open as an inlet port 13, and an outlet port 14 is provided in the pump base 11B. Note that the inlet port 13 has a flange 15 formed, and the outlet port 14 has a flange 16 formed. With the flange 15 of the inlet port 13, a sealed chamber, not shown, with high vacuum such as a process chamber of the semiconductor manufacturing device or the like communicates and is connected, and an auxiliary pump or the like, not shown, communicates and is connected with the flange 16 of the outlet port 14.

Inside the casing 11, a structure which exerts an exhaustion function is accommodated, and it sucks a gas (gas) in the sealed chamber through the inlet port 13 and exhausts it through the outlet port 14. As a result, a reaction gas and other gases for manufacturing semiconductors can be exhausted from the sealed chamber, for example. Note that, the example shown in FIG. 1 has a structure in which the vacuum pump 10 is disposed vertically, but the vacuum pump 10 may be laid and mounted on a lateral side of the sealed chamber or it may be mounted on an upper part of the sealed chamber with the inlet port 13 on a lower side.

In more detail, the structure which exerts the exhaustion function is roughly constituted by a stator body 17 fixed in the casing 11 and a rotating body 18 disposed rotatably relative to the stator body 17 and the like.

The rotating body 18 is constituted by a rotor blade 19, a rotating shaft 20 and the like.

The rotor blade 19 has a cylinder member 21 formed by a first cylinder portion 21a disposed on the inlet port 13 side (molecular-pump mechanism portion 10A) and a second cylinder portion 21b disposed on the outlet port 14 side (thread-groove type pump mechanism portion 10B) integrally.

The first cylinder portion 21a is a member having a substantially cylindrical shape and constitutes a rotor blade portion of the molecular-pump mechanism portion 10A. On an outer peripheral surface of the first cylinder portion 21a, a plurality of blades 22 extending outward radially from a surface parallel to a rotor blade 19 and a shaft center of the rotating shaft 20 are provided at substantially equal intervals in a rotating direction. Moreover, each of the blades 22 is inclined in the same direction only by a predetermined angle with respect to a horizontal direction. And in the first cylinder portion 21a, the plurality of blades 22 extending radially are formed in plural stages at predetermined intervals in an axis direction.

Moreover, approximately in the middle in the axis direction of the first cylinder portion 21a, a partition 23 to be joined to the rotating shaft 20 is formed. In the partition 23, a shaft hole 23a into which the upper end side of the rotating shaft 20 is inserted/mounted and a bolt hole, not shown, to which a mounting bolt 24 which fixes the rotating shaft 20 and the rotor blade 19 is mounted are formed.

The second cylinder portion 21b is a member with a cylindrically-shaped outer peripheral surface and constitutes a rotor blade portion of the thread-groove type pump mechanism portion 10B.

The rotating shaft 20 is a columnar member constituting a shaft of the rotating body 18, and a flange portion 20a which is screwed/fixed to the partition 23 of the first cylinder portion 21a through the mounting bolt 24 is integrally formed on an upper end portion. Moreover, in the rotating shaft 20, a hollow part 20b having a circular cross-sectional surface and formed along the rotating shaft center from a lower end surface toward an upper end side is formed. And the rotating shaft 20 is fixed to and integrated with the cylinder member 21 by screwing the mounting bolt 24 to a mounting hole of the flange portion 20a through the bolt hole, not shown, from the upper surface side of the partition 23 after the upper end portion is inserted into the shaft hole 23a from an inner side (lower side) of the first cylinder portion 21a until the flange portion 20a is brought into contact with a lower surface of the partition 23.

Moreover, substantially in the middle in the axis direction of the rotating shaft 20, a permanent magnet is fixed to the outer peripheral surface and constitutes a part of a rotor side of the motor portion 25. Magnetic poles formed by this permanent magnet on the outer periphery of the rotating shaft 20 are such that a half circumference of the outer peripheral surface is an N pole, and the remaining half circumference is an S pole.

Furthermore, a part on the rotating body 18 side in the radial magnetic-bearing portion 26 for supporting the rotating shaft 20 in the radial direction with respect to the motor portion 25 is formed on the upper end side (inlet port 13 side) of the rotating shaft 20, and a part on the rotating body 18 side in the radial magnetic-bearing portion 27 for similarly supporting the rotating shaft 20 in the radial direction with respect to the motor portion 25 is formed on the lower end side (outlet port 14 side). Moreover, on a lower end of the rotating shaft 20, a part on the rotating body 18 side of an axial magnetic-bearing portion 28 for supporting the rotating shaft 20 in the axis direction (thrust direction) is formed.

Moreover, in the vicinity of radial magnetic-bearing portions 26, 27, parts on the rotor sides of radial displacement sensors 29, 30 are formed, respectively, so that displacement of the rotating shaft 20 in the radial direction can be detected.

These parts on the rotor sides of the radial magnetic-bearing portions 26, 27 and the radial displacement sensors 29, 30 are constituted by a laminated steel plate in which steel plates are laminated in a shaft direction of the rotating body 18. This is to prevent generation of an eddy current in the rotating shaft 20 by magnetic fields generated by coils constituting the parts on the rotor sides of the radial magnetic-bearing portions 26, 27 and the radial displacement sensors 29, 30.

The rotor blade 19 is constituted by using metal such as stainless, an aluminum alloy and the like.

On an inner peripheral side of the casing 11, the stator body 17 is formed. The stator body 17 is constituted by a stator blade 31 provided on the inlet port 13 side (molecular-pump mechanism portion 10A side), a thread-groove spacer 32 provided on the outlet port 14 side (thread-groove type pump mechanism portion 10B side), a stator of the motor portion 25, stators of the radial magnetic-bearing portions 26, 27, a stator of the axial magnetic-bearing portion 28, stators of the radial displacement sensors 29, 30, a collar 36, a stator column 35 and the like.

The stator blade 31 is constituted by a blade 33 inclined only by a predetermined angle from a plane perpendicular to an axis of the rotating shaft 20 and extending from the inner peripheral surface of the casing 11 toward the rotating shaft 20. Moreover, regarding the stator blades 31, in the molecular-pump mechanism portion 10A, the blades 33 are formed in plural stages alternately with the blades 22 of the rotor blades 19 in the axis direction. The blade 33 on each stage is separated from each other by a spacer 34 having a cylindrical shape.

The thread-groove spacer 32 is a columnar member in which a spiral groove 32a is formed in an inner peripheral surface. The inner peripheral surface of the thread-groove spacer 32 is configured to face the outer peripheral surface of the second cylinder portion 21b in the cylinder member 21 with a predetermined clearance (gap) between them. A direction of the spiral groove 32a formed in the thread-groove spacer 32 is a direction toward the outlet port 14 when the gas is transported in a rotating direction of the rotating body 18 in the spiral groove 32a. A depth of the spiral groove 32a is configured to become shallower as it gets closer to the outlet port 14 so that the gas transported through the spiral groove 32a is compressed as it gets closer to the outlet port 14.

The stator blade 31 and the thread-groove spacer 32 are constituted by using metal such as stainless, an aluminum alloy and the like.

The pump base 11B is a member having a substantially short cylindrical shape having an opening 39 penetrating at a center in an up-down direction. On an upper surface side of the pump base 11B, the stator column 35 having a cylindrical shape is mounted concentrically with a rotation axis of the stator body 17 by inserting the lower end side into the opening 39 for engagement and by directing the upper surface side to a direction of the inlet port 13. The stator column 35 supports the parts on the stator sides of the motor portion 25, the radial magnetic-bearing portions 26, 27, and the radial displacement sensors 29, 30. On the other hand, on the lower surface side of the pump base 11B, the base end lid 11C is mounted by the mounting bolt 41 and is integrated with the pump base 11B. That is, the base end lid 11C forms the casing 11 together with the pump case 11A and the pump base 11B.

In the motor portion 25, stator coils with predetermined pole numbers are disposed at equal intervals on the inner peripheral sides of the stator coils so that a rotating magnetic field can be generated around the magnetic pole formed on the rotating shaft 20. Moreover, on the outer periphery of the stator coil, the collar 36, which is a cylinder member constituted by metal such as stainless, is disposed so as to protect the motor portion 25.

The radial magnetic-bearing portions 26, 27 are constituted by coils disposed at every 90 degrees around the rotating axis. The radial magnetic-bearing portions 26, 27 magnetically float the rotating shaft 20 in the radial direction by attracting the rotating shaft 20 by a magnetic field generated by these coils.

On a bottom part of the stator column 35, the axial magnetic-bearing portion 28 is formed. The axial magnetic-bearing portion 28 is constituted by a disc extending from the rotating shaft 20 and coils disposed above and below this disc. When the magnetic field generated by these coils attract this disc, the rotating shaft 20 is magnetically floated in the axis direction.

On the inlet port 13 of the casing 11, the flange 15 extending to an outer peripheral side of the pump case 11A is formed. In the flange 15, a bolt hole 37 through which a bolt, not shown, is inserted, and an annular groove 38 to which an O-ring for keeping airtightness with a flange on a vacuum vessel side, also not shown, is attached are formed.

At a center of the base end lid 11C, a cooling-rod mounting hole 42 is formed, and a cooling rod 43 is closely fixed and attached to the cooling-rod mounting hole 42 without a gap from the cooling-rod mounting hole 42 so that the degree of vacuum inside the vacuum pump 10 is not lowered. Note that the mounting of the base end lid 11C and the cooling rod 43 are, for example, integrated by fabricating completely integrally or by welding, brazing or the like. The base end lid 11C integrated with the cooling rod 43 is closely connected to the pump base 11B without a gap through an O-ring 40.

The cooling rod 43 is formed having a rod shape with an outer diameter smaller than an inner diameter of the hollow part 20b formed in the rotating shaft 20. Regarding the cooling rod 43, an upper end side penetrates the axial magnetic-bearing portion 28 and is inserted/disposed in the hollow part 20b from a lower end side of the rotating shaft 20 in a state of non-contact with the axial magnetic-bearing portion 28 and the rotating shaft 20, a lower end side is fixed to the base end lid 11C, which is a part of the casing 11, and moreover, an end portion 43a of the cooling rod 43 is led out to an outside of the casing 11. In this way, the outer peripheral surface of the cooling rod 43 inserted into the hollow part 20b and the inner peripheral surface of the hollow part 20b are not in contact with each other, and a gap σ is provided between the outer peripheral surface of the cooling rod 43 and the inner peripheral surface of the hollow part 20b.

The cooling rod 43 is not the one that injects a refrigerant or the like into the gap between the cooling rod 43 and the rotating body 18 but absorbs a radiation heat from the rotating shaft 20. The heat inside the cooling rod 43 is radiated to an outside through the end portion withdrawn from a lower surface of the base end lid 11C. That is, when heat generation occurs on the rotating body 18 side and the rotating shaft 20 is heated, the cooling rod 43 absorbs the radiation heat from the rotating shaft 20 and takes the heat away from the rotating shaft 20, and by radiating the absorbed heat to the outside, it can cool the rotating shaft 20 and the rotating body 18 side so that the temperatures thereof do not rise to a predetermined temperature or more.

Note that, as the cooling rod 43, those of metal in general with good heat transfer characteristics such as aluminum (Al), an aluminum alloy, copper (Au), a copper alloy, a beryllium alloy and the like, for example, may be used. Moreover, it may be such a structure that the inside of the cooling rod 43 is made hollow, and air, water, ethylene glycol (C2H6O2) or the like is sealed as the refrigerant inside the hollow.

On the other hand, for the purpose of facilitating transfer of the radiation heat, the rotating shaft 20 may be formed of ceramic, carbon or the like, and moreover, coating treatment of a black paint or ceramic coating treatment, black nickel-plating treatment, anodization treatment, resin painting treatment or the like is preferably applied to the inner peripheral surface of the hollow part 20b opposed to the outer peripheral surface of the cooling rod 43.

The vacuum pump 10 constituted as above operates as follows and exhausts a gas from the vacuum vessel.

First, the radial magnetic-bearing portions 26, 27 and the axial magnetic-bearing portion 28 magnetically float the entirety of the rotating body 18 through the rotating shaft 20 so as to support the rotating body 18 in a non-contact manner in the space.

Subsequently, the motor portion 25 operates and rotates the rotating shaft 20 in a predetermined direction. That is, it rotates the rotating body 18 in the predetermined direction. A rotational speed is approximately 30,000 rotations per minute, for example. In this example, the rotating direction of the rotating body 18 is supposed to be a clockwise direction when seen from the inlet port side, but the vacuum pump 10 can be configured so as to rotate in a counterclockwise direction.

When the rotating body 18 rotates, by means of actions of the blade 22 of the rotor blade 19 and the blade 33 of the stator blade 31 in the stator body 17, the gas is sucked through the inlet port 13 and is compressed more as it goes to a lower stage. The gas compressed in the molecular-pump mechanism portion 10A is further compressed in the thread-groove type pump mechanism portion 10B and is exhausted through the outlet port 14.

By the way, in the vacuum pump 10, a heat is generated when the gas is compressed in the vacuum pump. Moreover, by means of heat generation from the coils and the rotors of the motor portion 25, the coils of the radial magnetic-bearing portions 26, 27, the coils and rotors of the axial magnetic-bearing portion 28 and the like, the entire rotating body 18 including the rotating shaft 20 generates heat. Thus, there is a concern that lowering of an output or the motor, rotation vibration and the like can easily occur. Then, in order to solve this problem, it becomes necessary to remove the heat on the rotating body 18 side and to cool a temperature of the entire rotating body 18 to a required temperature.

In the vacuum pump 10 in this example, the cooling rod 43 is inserted/disposed in the hollow part 20b from the lower end side of the rotating shaft 20. Since the cooling rod 43 is inserted/disposed in the hollow part 20b, the heat generated in the rotating body 18 is transferred to the cooling rod 43 as the radiation heat, and this radiation heat is received and absorbed by the cooling rod 43. The heat absorbed by the cooling rod 43 is transferred inside of the cooling rod 43 and is caused to escape to the outside through the end portion 43a withdrawn to the outer side of the casing 11 from the lower surface of the base end lid 11C. In this way, since the cooling rod 43 absorbs the heat on the rotating body 18 side and causes it to escape to the outside of the casing 11, the temperature on the rotating body 18 side is cooled and kept so as not to rise, and the entire rotating body 18 can be kept at the predetermined temperature or less at all time. As a result, lowering of the output of the motor portion 25 or generation of rotation vibration of the rotating body 18 can be prevented.

Moreover, since it is no such a structure that injects the refrigerant into the hollow part 20b, there is no need to apply the seal structure which prevents leakage of the refrigerant between the stator body 17 and the rotating body 18 or between the cooling rod 43 and the rotating body 18, and size reduction and cost down can be realized. Furthermore, since there is no directly intruding refrigerant on the airgap side of the motor portion 25 or the like and the sides of the rotor blade 19, the stator blade 31 and the like, the rotating body 18 can be cooled without lowering the degree of vacuum, and the vacuum pump 10 can be driven with high accuracy. Moreover, since there is no refrigerant in direct contact with the rotating body 18 and the stator body 17, erosion of the rotating body 18 or the stator body 17 can be prevented, and durability can be improved.

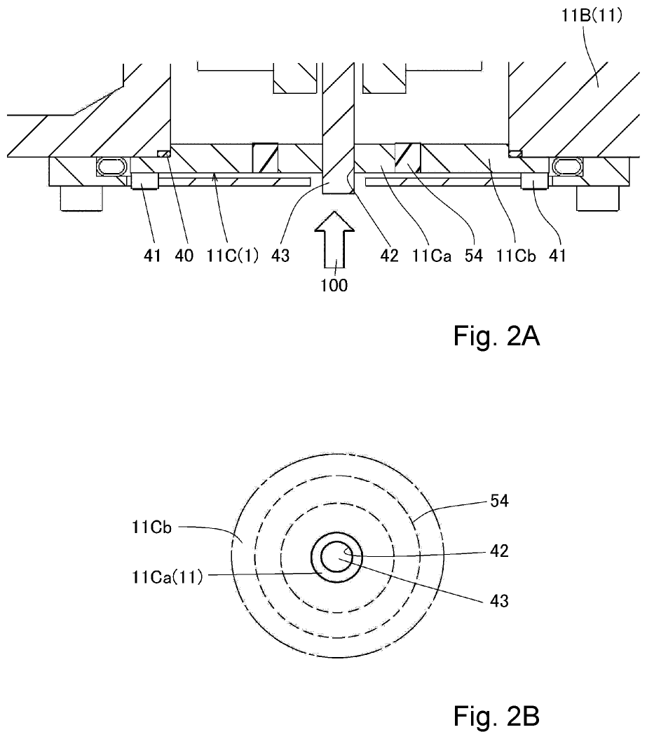

Note that, in the vacuum pump 10 in this example, such a structure that the base end lid 11C and the cooling rod 43 are integrated is disclosed, but if the cooling rod 43 and the base end lid 11C are simply integrated, there is a concern that the heat on the casing 11 side is transferred from the base end lid 11C to the cooling rod 43 between the cooling rod 43 and the base end lid 11C, whereby the cooling rod 43 is heated. In order to prevent this, the base end lid 11C is preferably constituted as shown in FIGS. 2A and 2B, for example.

That is, FIGS. 2A and 2B are diagrams for explaining another variation of the vacuum pump 10 shown in FIG. 1, in which FIG. 2A is a schematic vertical-section side view illustrating a structure in the periphery of the base end lid 11C in FIG. 1 in an enlarged manner, and FIG. 2B is a plan view of a part of the base end lid 11C and the cooling rod 43 when seen from an arrow 100 direction in FIG. 2A. Note that the members in FIGS. 2A and 2B given the same reference signs as in FIG. 1 are the same members as the members illustrated in FIG. 1, and duplicated explanation will be omitted.

The base end lid 11C shown in FIGS. 2A and 2B is divided into an inner base-end lid portion 11Ca and an outer base-end lid portion 11Cb, and an insulating material 54 as a first insulating material is integrally provided between the inner base-end lid portion 11Ca and the outer base-end lid portion 11Cb. And the cooling rod 43 is closely fixed to the cooling-rod mounting hole 42 formed in the inner base-end lid portion 11Ca and integrated.

In the structure of the vacuum pump 10 shown in FIGS. 2A and 2B, the heat of the base end lid 11C is shut out by the insulating material 54 between the inner base-end lid portion 11Ca and the outer base-end lid portion 11Cb, and the heat from the outer base-end lid portion 11Cb is not directly transferred to the cooling rod 43. And the cooling rod 43 absorbs the radiation heat from the rotating body 18 side without directly receiving the heat from the outer base-end lid portion 11Cb, whereby a cooling effect can be improved. Note that, as the insulating material 54, a stainless alloy, ceramics, plastic, glass, glass wool and the like can be cited, for example. Moreover, the similar effect can be expected even if the inner base-end lid portion 11Ca is eliminated, and the cooling rod 43 and the base end lid 11C are integrated with the insulating material 54 interposed between the cooling rod 43 and the outer base-end lid portion 11Cb.

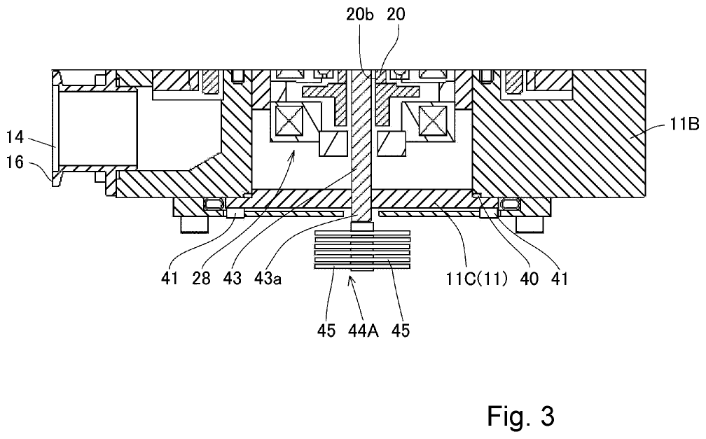

Moreover, the vacuum pump 10 shown in FIG. 1 has such a structure, as the structure for radiating the heat absorbed by the cooling rod 43 to the outside, that the end portion 43a of the cooling rod 43 is simply led out to the outer side of the base end lid 11C, which is the casing 11. However, as a means for improving the heat radiation of the cooling rod 43, by providing such a cooling structure for improving the heat radiation performance by mounting a heat-radiation mechanism member on the end portion 43a of the cooling rod 43 as shown in FIG. 3 to FIG. 5, for example, the cooling function can be further improved.

FIG. 3 is a diagram for explaining another variation of the vacuum pump 10 shown in FIG. 1 and a schematic vertical-section side view showing a structure in the periphery of the base end lid 11C of the vacuum pump 10 shown in FIG. 1 in an enlarged manner. Note that the members in FIG. 3 given the same reference signs as in FIG. 1 are the same members as the members illustrated in FIG. 1, and duplicated explanation will be omitted.

In the vacuum pump 10 shown in FIG. 3, a heat radiation mechanism 44A is mounted on the end portion 43a of the cooling rod 43. The heat radiation mechanism 44A has a structure in which a plurality of heat radiation plates 45 are disposed substantially at equal intervals along the rotating shaft center. This heat radiation mechanism 44A has such a structure that the cooling rod 43 can be naturally cooled by radiating the heat from the cooling rod 43 by the heat radiation plates 45.

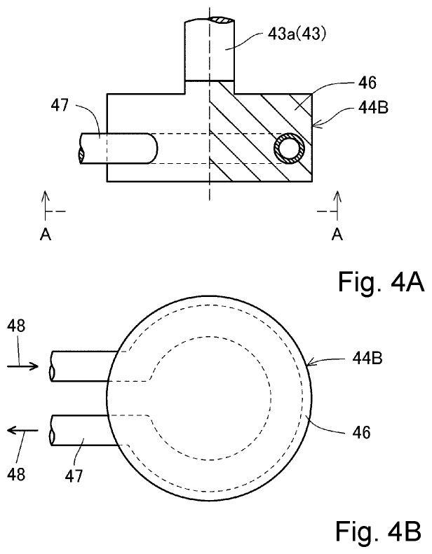

FIGS. 4A and 4B are diagrams for explaining one variation of the heat radiation mechanism 44A shown in FIG. 3 and show a heat radiation mechanism 44B as the variation. FIG. 4A is a side view showing a part of the heat radiation mechanism 44B in a broken manner, and FIG. 4B is a bottom view of the heat radiation mechanism 44B when seen from an arrow A-A line direction in FIG. 4A.

The heat radiation mechanism 44B shown in FIGS. 4A and 4B has a structure which employs a cooling method for forcedly cooling a heat-radiation mechanism main body 46 by disposing piping 47 substantially annularly around inside the block-shaped heat-radiation mechanism main body 46 and by causing a cooling water 48 to flow inside the piping 47. This heat-radiation mechanism 44B has such a structure that can forcedly cool the cooling rod 43 by absorbing the heat from the cooling rod 43 by the heat-radiation mechanism main body 46 and further by radiating the heat to the water flowing through the piping 47.

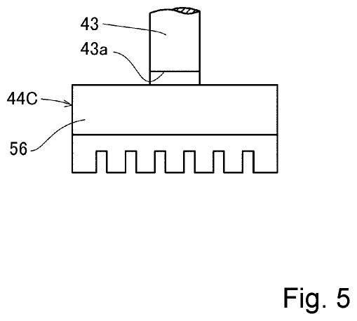

FIG. 5 is a diagram for explaining another variation of the heat radiation mechanism 44A shown in FIG. 3 and is a side view showing a heat radiation mechanism 44C.

The heat radiation mechanism 44C shown in FIG. 5 has a heat-radiation mechanism structure with a Peltier-type unit 56 using a Peltier element in which the Peltier element, not shown, which can freely perform cooling/heating/temperature control by a direct current is disposed inside the heat-radiation mechanism main body 46 and the heat of the cooling rod 43 is absorbed by causing the electric current to flow through the Peltier element so as to forcedly cool the cooling rod 43.

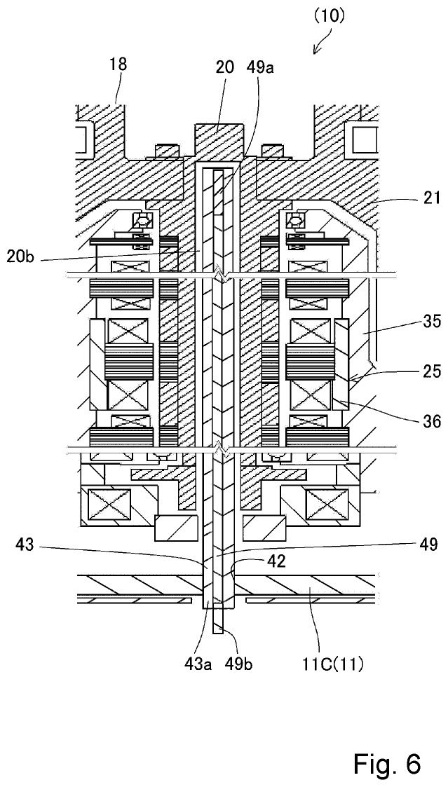

FIG. 6 is a diagram for explaining still another variation of the vacuum pump 10 shown in FIG. 1 and is a partially enlarged view of the vacuum pump 10 particularly having a structure that a heat pipe 49 is embedded in the cooling rod 43. Note that the members in FIG. 6 given the same reference signs as in FIG. 1 are the same members as the members illustrated in FIG. 1, and duplicated explanation will be omitted.

In FIG. 6, the heat pipe 49 itself is the one known widely. The heat pipe 49 has, in principle, a high temperature portion (heat absorbing portion) 49a and a low temperature portion (heat radiation portion) 49b, and a circulating hydraulic fluid such as water, a refrigerant fluid and the like, for example, is contained inside. The hydraulic fluid absorbs a heat and evaporates on an inner wall of the high temperature portion 49a, and a hydraulic fluid steam passes through a cavity, not shown, provided inside the heat pipe 49, moves to the low temperature portion 49b and is cooled. The hydraulic fluid steam cooled in the low temperature portion 49b collects and returns to a liquid and is absorbed in a wick (core of a capillary pipe structure) of the inner wall, and the hydraulic fluid returns to the high temperature portion along the wick in the inner wall. That is, by creating a temperature difference between the high temperature portion 49a and the low temperature portion 49b, a circulation process of heat exchange is generated so that heat transfer occurs from the high temperature portion to the low temperature portion.

And the heat pipe 49 in the vacuum pump 10 shown in FIG. 6 is embedded in the cooling rod 43 in a state where the high temperature portion 49a, which is the heat absorbing portion, is disposed above the cooling rod 43 and the low temperature portion 49b, which is the heat radiation portion, is disposed on the end portion 43a of the cooling rod 43, and moreover, a part of the low temperature portion 49b is disposed in a state withdrawn to the outside of the casing 11 from the end portion 43a of the cooling rod 43. Note that the heat pipe 49 is disposed inside the hollow part 20b of the rotating shaft 20 at a position corresponding to a spot where the high temperature portion 49a of the heat pipe 49 requires cooling of the rotating body 18.

As described above, in the vacuum pump 10 using the cooling rod 43 in which the heat pipe 49 is embedded, the heat generated in the rotating body 18 is transferred as the radiation heat to the cooling rod 43, this is received by the high temperature portion 49a, which is the heat absorbing portion of the heat pipe 49, is moved to the low temperature portion 49b, which is the heat radiation portion, and is cooled. The heat cooled in the low temperature portion 49b returns to the high temperature portion 49a and cools the high temperature portion 49a, whereby the cooling rod 43 is cooled at the same time. By means of this cooling of the cooling rod 43, the temperature on the rotating body 18 side is also kept so as not to become the predetermined temperature or more, and the entire rotating body 18 can be kept at the predetermined temperature or less at all time. As a result, lowering of the output of the motor portion 25 or generation of rotation vibration of the rotating body 18 can be prevented.

Note that, in the variation in FIG. 6, the structure in which the heat pipe 49 is embedded in the cooling rod 43 is disclosed, but the heat pipe 49 itself may be disposed as the cooling rod 43 in the hollow part 20b of the rotating shaft 20 without embedding the heat pipe 49 in the cooling rod 43.

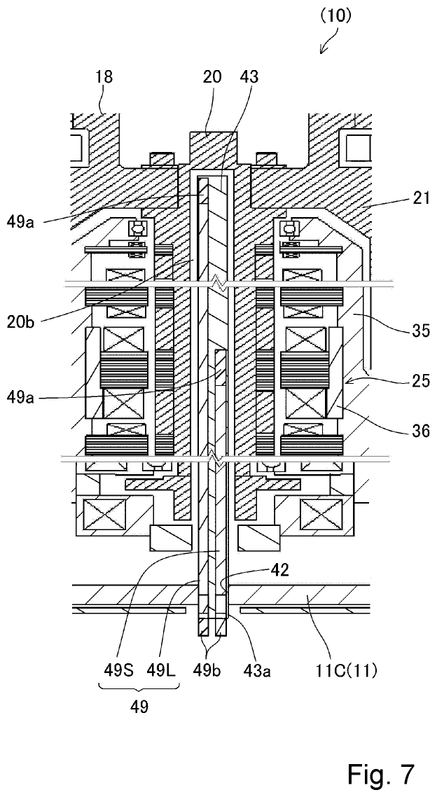

Moreover, in the variation shown in FIG. 6, the structure in which the single heat pipe 49 is embedded in the cooling rod 43 is disclosed, but in the hollow part 20b of the rotating shaft 20 as shown in FIG. 7, for example, a plurality of the heat pipes 49 (two in FIG. 7, that is, a heat pipe 49L and a heat pipe 49S) with different lengths may be combined and disposed at plural positions by shifting positions along the rotating shaft center or the like.

That is, the variation shown in FIG. 7 has such a structure that the high temperature portion 49a, which is the heat absorbing portion of the longer heat pipe 49L is disposed at a spot on an upper part requiring cooling of the cooling rod 43, while the high temperature portion 49a of the shorter heat pipe 49S is disposed at a spot in a middle part in the up-down direction similarly requiring cooling of the cooling rod 43 so that both the upper part and the middle part of the rotating body 18 can be cooled with an emphasis. Note that, in this case, too, the heat pipe 49L and the heat pipe 49S may be disposed in the hollow part 20b of the rotating shaft 20 with the heat pipe 49L and the heat pipe 49S themselves as the cooling rods 43, respectively, instead of embedding the heat pipe 49L and the heat pipe 49S in the cooling rod 43.

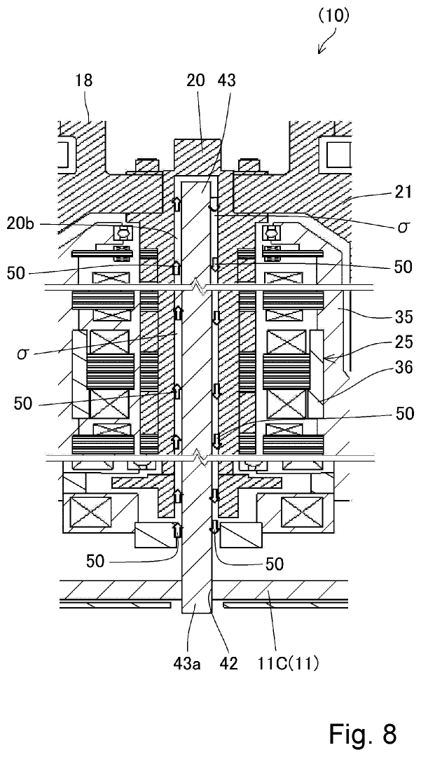

FIG. 8 is a partially enlarged view illustrating still another variation of the vacuum pump 10 shown in FIG. 1 and is a structure in which a purge gas 50 is caused to flow through the gap σ between the cooling rod 43 and the hollow part 20b of the rotating shaft 20. As the purge gas 50, nitrogen or the like which is an inactive gas, for example, is used.

In this structure, the purge gas 50 to be caused to flow through the gap σ between the cooling rod 43 and the hollow part 20b of the rotating shaft 20 is caused to flow into the hollow part 20b from the lower end side of the rotating shaft 20 toward the upper end side, without remaining at a same position in the gap σ, and turns back at the upper end side in the hollow part 20b and goes out of the hollow part 20b again from the lower end side. As a result, in the casing 11, the cooling rod 43 absorbs the radiation heat of the rotating body 18, and by means of the absorption of the heat by the flow of the purge gas 50, both of the following cooling effects, the cooling effect by the cooling rod 43 and the cooling effect by the purge gas 50, can be obtained. The purge gas can directly intrude to the airgap side of the motor portion or the like and the sides of the rotor blades and the like. A type of the purge gas which is preferable for prevention of erosion of the components by the purge gas is nitrogen or the like, which is an inactive gas, for example.

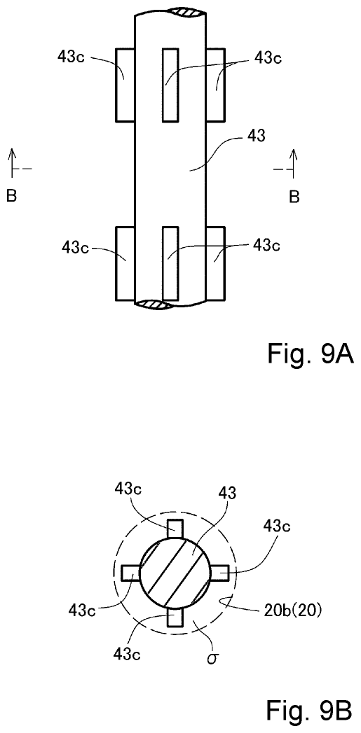

Moreover, in the structure in which the purge gas 50 is caused to flow through the gap σ between the cooling rod 43 and the hollow part 20b of the rotating shaft 20 shown in FIG. 8, such a structure may be provided that, on the outer peripheral surface of the cooling rod 43, a fin 43c, a spiral fin 43d, and a spiral fin 43e protruded from the outer peripheral surface toward the inner peripheral surface of the hollow part 20b are further provided as shown in FIGS. 9A and 9B to FIG. 11.

FIGS. 9A and 9B are partially enlarged views of the cooling rod 43 with a part of the cooling rod 43 in the vacuum pump 10 shown in FIG. 1 modified, in which FIG. 9A is a side view of the cooling rod 43, and FIG. 9B is a B-B line sectional arrow view of FIG. 9A. The cooling rod 43 shown in FIGS. 9A and 9B has the fins 31a extending along the rotating shaft center at each 90-degree displacement in a circumferential direction provided intermittently along the rotating shaft center. As described above, in the structure with the fins 31a provided on the outer peripheral surface of the cooling rod 43, when the purge gas 50 (not shown in FIGS. 9A and 9B) flows to enter the gap σ of the hollow part 20b from the lower end side of the hollow part 20b, to go round in the gap σ of the hollow part 20b, and to go out of the hollow part 20b again from the lower end side, the purge gas 50 is agitated by the fin 31a in the gap σ of the hollow part 20b, whereby heat transfer to the purge gas 50 is promoted, and the cooling effect by the purge gas 50 can be further obtained.

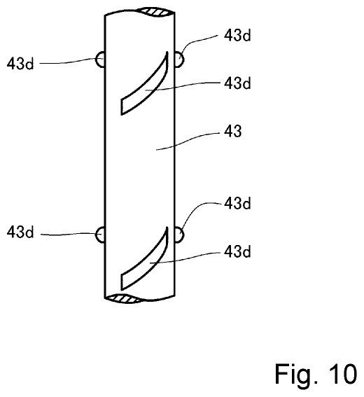

FIG. 10 is a partially enlarged view of the cooling rod 43 with a part of the cooling rod 43 shown in FIG. 1 modified. The cooling rod 43 shown in FIG. 10 has the spiral fins 31b inclined spirally with respect to the rotating shaft center provided on the outer peripheral surface of the cooling rod 43 intermittently along the rotating shaft center. As described above, in the structure in which a spiral fin 43d is provided on the outer peripheral surface of the cooling rod 43, when the purge gas 50 (not shown in FIG. 10) flows to enter the hollow part 20b from the lower end side of the hollow part 20b, to go round in the hollow part 20b, and to go out of the hollow part 20b again from the lower end side, the purge gas 50 is agitated by the spiral fin 43d in the hollow part 20b. As a result, heat transfer from the rotating body 18 to the purge gas 50 in the hollow part 20b is promoted, and the cooling effect by the purge gas 50 can be further obtained.

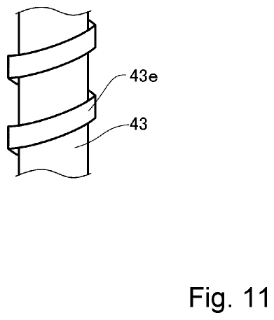

FIG. 11 is a partially enlarged view of the cooling rod 43 with a part of the cooling rod 43 shown in FIG. 1 modified. The cooling rod 43 shown in FIG. 11 has the single continuous spiral fin 43e inclined spirally with respect to the rotating shaft center provided on the outer peripheral surface of the cooling rod 43 along the rotating shaft center. As described above, in the structure in which the spiral fin 43e is provided on the outer peripheral surface of the cooling rod 43, when the purge gas 50 (not shown in FIG. 11) flows to enter the hollow part 20b from the lower end side of the hollow part 20b, to go round in the hollow part 20b, and to go out of the hollow part 20b again from the lower end side, the purge gas 50 is agitated by the spiral fin 43e in the hollow part 20b, whereby the heat transfer to the purge gas 50 is promoted, and the cooling effect by the purge gas 50 can be further obtained.

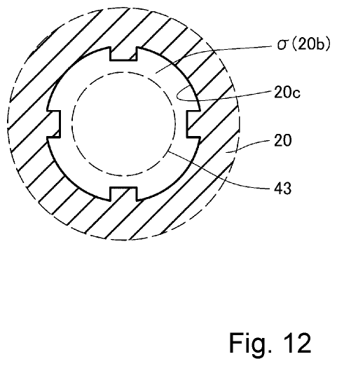

Moreover, in the structure in which the purge gas 50 is caused to flow through the gap σ between the cooling rod 43 and the hollow part 20b of the rotating shaft 20 shown in FIG. 8, the structure may be further such that, on the inner peripheral surface of the hollow part 20b, a groove 20c extending along the rotating shaft center is provided as shown in FIG. 12. In the structure in which the groove 20c is provided in the inner peripheral surface of the hollow part 20b as above, when the purge gas 50 (not shown in FIG. 12) flows to enter the hollow part 20b from the lower end side of the hollow part 20b, to go round in the hollow part 20b, and to go out of the hollow part 20b again from the lower end side, the purge gas 50 is agitated by the groove 20c in the hollow part 20b, whereby the heat transfer to the purge gas 50 is promoted, and the cooling effect by the purge gas 50 can be further obtained. Note that the groove 20c here can be also made a groove formed having a spiral shape along the rotating shaft center, and in the case of the spiral groove 20c, the purge gas 50 is more agitated, and the cooling effect by the purge gas 50 is further improved.

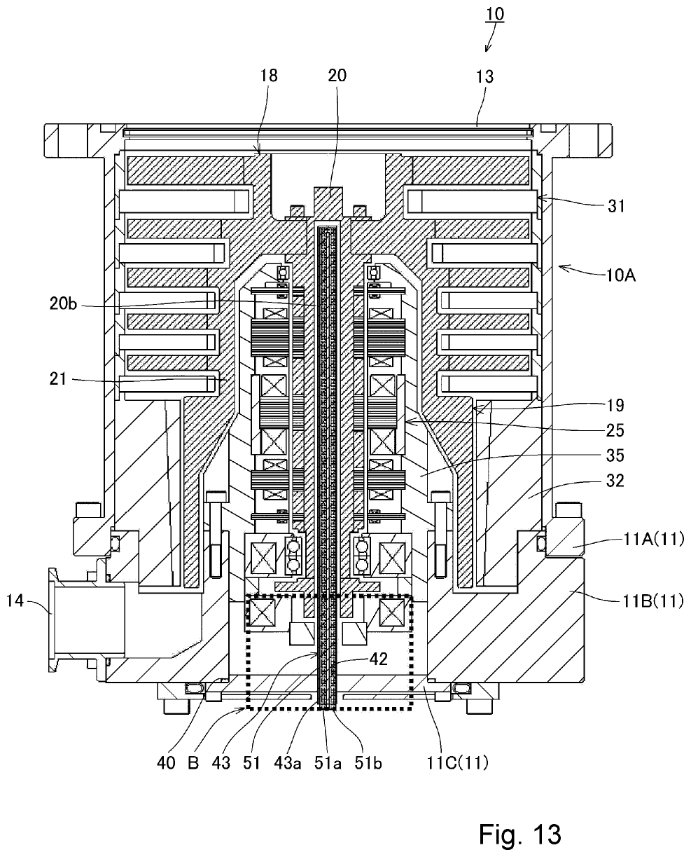

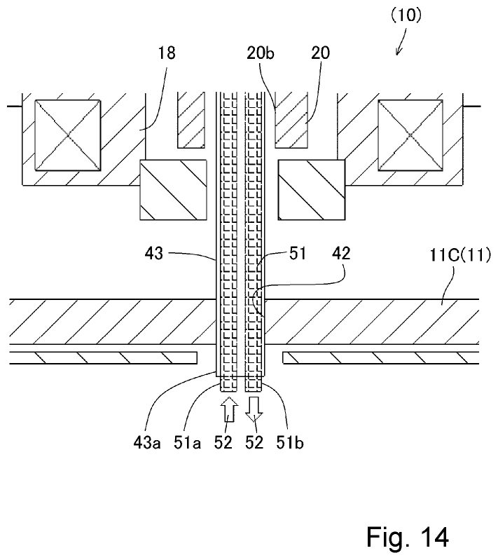

FIG. 13 and FIG. 14 are diagrams showing still another variation of the vacuum pump 10 shown in FIG. 1, in which FIG. 13 is a schematic vertical-section side view of the vacuum pump 10, and FIG. 14 is a B-part enlarged view of FIG. 13. Note that the members in FIG. 13 and FIG. 14 given the same reference signs as in FIG. 1 are the same members as the members illustrated in FIG. 1, and duplicated explanation will be omitted.

The vacuum pump 10 shown in FIG. 13 and FIG. 14 has a structure in which a refrigerant piping 51 is embedded in the cooling rod 43.

The refrigerant piping 51 is a pipe-shaped member in which a refrigerant 52 can be passed through. The refrigerant piping 51 is laid, as shown in FIG. 13, so that it starts at the lower end side of the cooling rod 43, goes toward the upper end side, is folded back to an opposite direction on the upper end side (middle part) of the cooling rod 43 and goes out again to the outside of the cooling rod 43 from the lower end side, and a refrigerant inlet portion 51a and a refrigerant outlet portion 51b are both withdrawn from the end portion 43a on the lower side of the cooling rod 43 to the outside.

And the refrigerant inlet portion 51a and the refrigerant outlet portion 51b of the refrigerant piping 51 are connected to a refrigerant exhaust port and a refrigerant return port of a refrigerant machine, none of them being shown, and the refrigerant 52 exhausted from the refrigerant exhaust port of the refrigerant machine is sent into the refrigerant piping 51 from the refrigerant inlet portion 51a of the refrigerant piping 51, passes through the inside of the refrigerant piping 51, is exhausted from the refrigerant outlet portion 51b, and returns to the refrigerant return port of the refrigerant machine.

And in the vacuum pump 10 using the cooling rod 43 shown in FIG. 13 and FIG. 14, as shown in FIG. 14, when the refrigerant 52 flows in the refrigerant piping 51, the heat of the cooling rod 43 warmed by absorbing the radiation heat on the rotating shaft 20 side is absorbed by the refrigerant 52 so as to forcedly lower the temperature of the cooling rod 43, whereby the cooling capacity by the cooling rod 43 is improved. And by keeping the temperature on the rotating body 18 side so that it does not become the predetermined temperature or more, and the entire rotating body 18 can be kept to the predetermined temperature or less at all time. As a result, lowering of the output of the motor portion 25 and generation of rotation vibration of the rotating body 18 can be prevented.

Note that the refrigerant piping 51 may be provided in plural and may have a structure branching from/merging with the refrigerant machine.

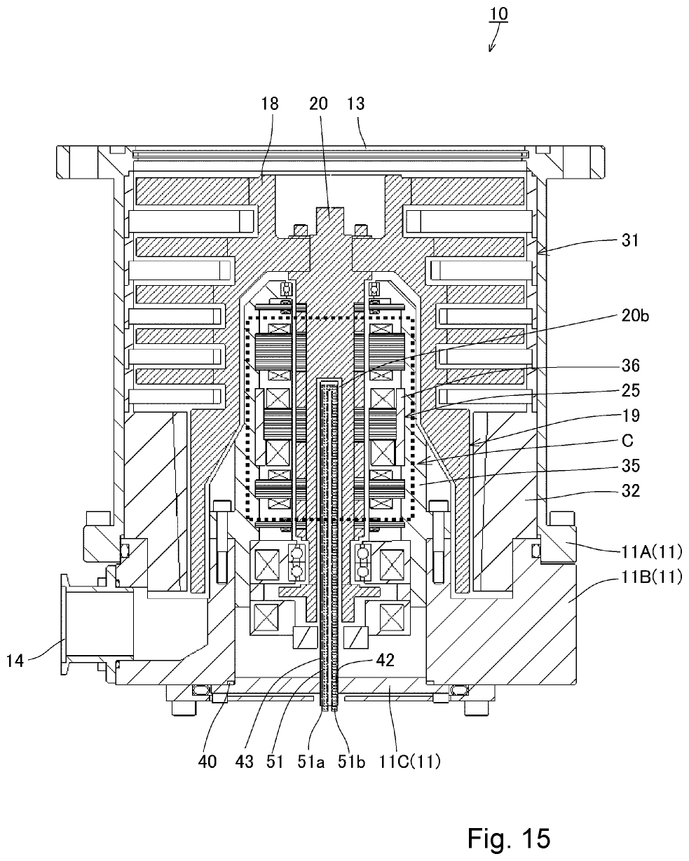

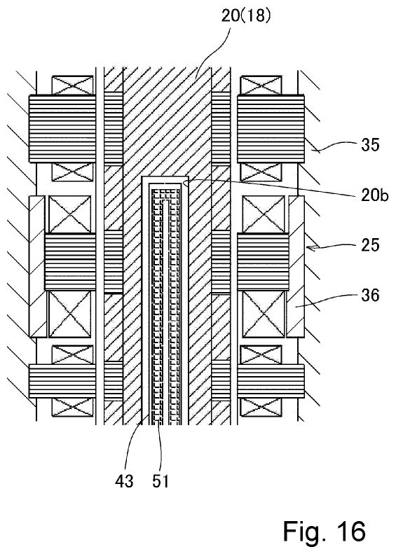

FIG. 15 and FIG. 16 are diagrams showing still another variation of the vacuum pump 10 shown in FIG. 1, in which FIG. 15 is a schematic vertical-section side view of the vacuum pump 10, and FIG. 16 is a C-part enlarged view of the vacuum pump 10 shown in FIG. 15. Note that the members in FIG. 15 and FIG. 16 given the same reference signs as in FIG. 1 are the same members as the members illustrated in FIG. 1, and duplicated explanation will be omitted.

The vacuum pump 10 shown in FIG. 15 and FIG. 16 has such a structure that an axial length of the hollow part 20b shown in FIG. 1 from the lower end surface and the axial length of the cooling rod 43 are made smaller, respectively, and the cooling rod 43 is not disposed at a spot not requiring the cooling. That is, cost reduction is promoted by not forming the hollow part 20b at a spot not requiring the cooling in the rotating shaft 20, and a heat transfer amount at the spot not requiring the cooling by the cooling rod 43 is reduced so that the cooling can be realized efficiently.

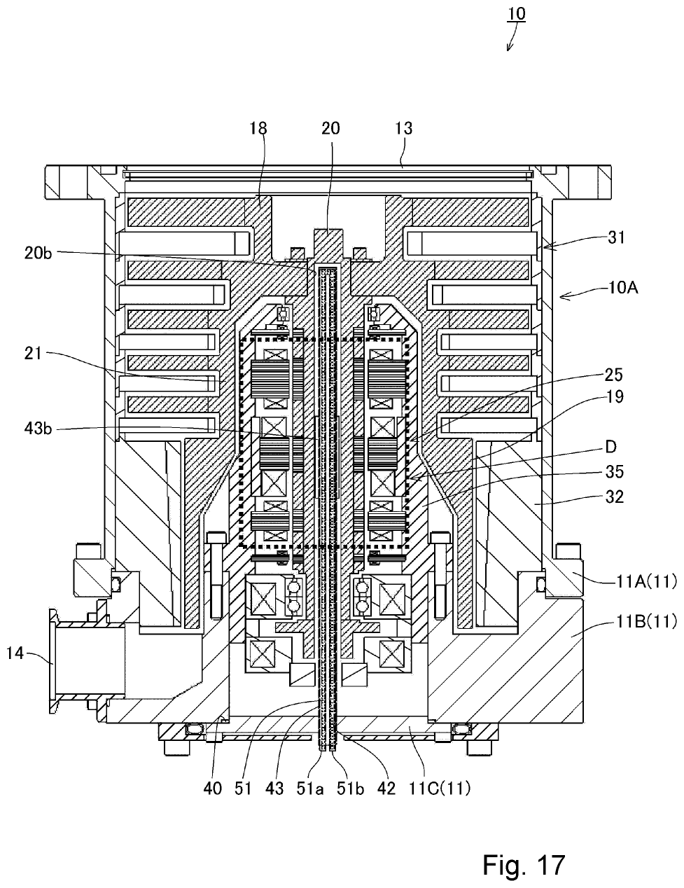

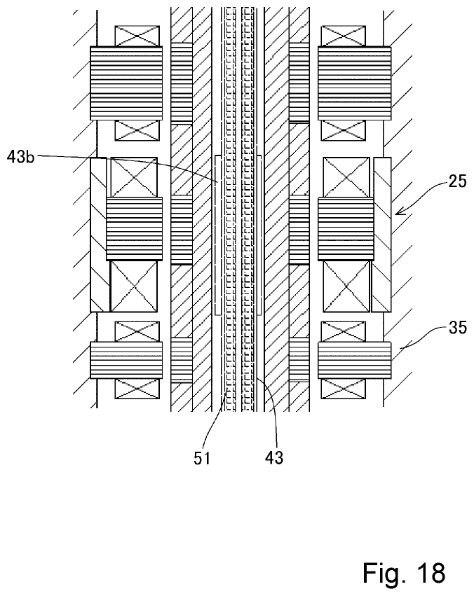

FIG. 17 and FIG. 18 are diagrams illustrating still another variation of the vacuum pump 10 shown in FIG. 1, in which FIG. 17 is a schematic vertical-section side view of the vacuum pump 10, and FIG. 18 is a D-part enlarged view of FIG. 17.

Note that the members in FIG. 17 and FIG. 18 given the same reference signs as in FIG. 1 are the same members as the members illustrated in FIG. 1, and duplicated explanation will be omitted.

In the vacuum pump 10 shown in FIG. 17 and FIG. 18, in the cooling rod 43 shown in FIG. 13 and FIG. 14, the fins 43b formed along the rotating shaft center are provided at positions at equal intervals in the circumferential direction (90-degree interval in this example) on the outer peripheral surface of the cooling rod 43. Note that the position where the fin 43b is provided is a spot corresponding to the motor portion 25 requiring the cooling.

When the fins 43b are provided on the outer peripheral surface of the cooling rod 43 as in the vacuum pump 10 shown in FIG. 17 and FIG. 18, a surface area at the spot of the cooling rod 43 corresponding to the motor portion 25 requiring the cooling becomes larger than the surface area of a spot not requiring the cooling. Therefore, since the fin 43b is provided at the spot requiring the cooling and the fin 43b is not provided at the spot not requiring the cooling in this structure, by increasing the heat transfer amount at the spot requiring the cooling as compared with the heat transfer amount at the spot not requiring the cooling, the cooling of the spot requiring the cooling can be performed effectively.

Note that, instead of provision of the fins 43b on the outer periphery of the cooling rod 43 as in the vacuum pump 10 shown in FIG. 17 and FIG. 18, the cooling effect may be varied by changing the surface area of the cooling rod 43 such that the surface area of the cooling rod 43 not requiring the cooling is reduced by decreasing an outer peripheral diameter of the cooling rod 43 at the spot not requiring the cooling, or to the contrary, the surface area is increased by increasing the outer peripheral diameter of the cooling rod 43 at the spot corresponding to the spot requiring the cooling, for example.

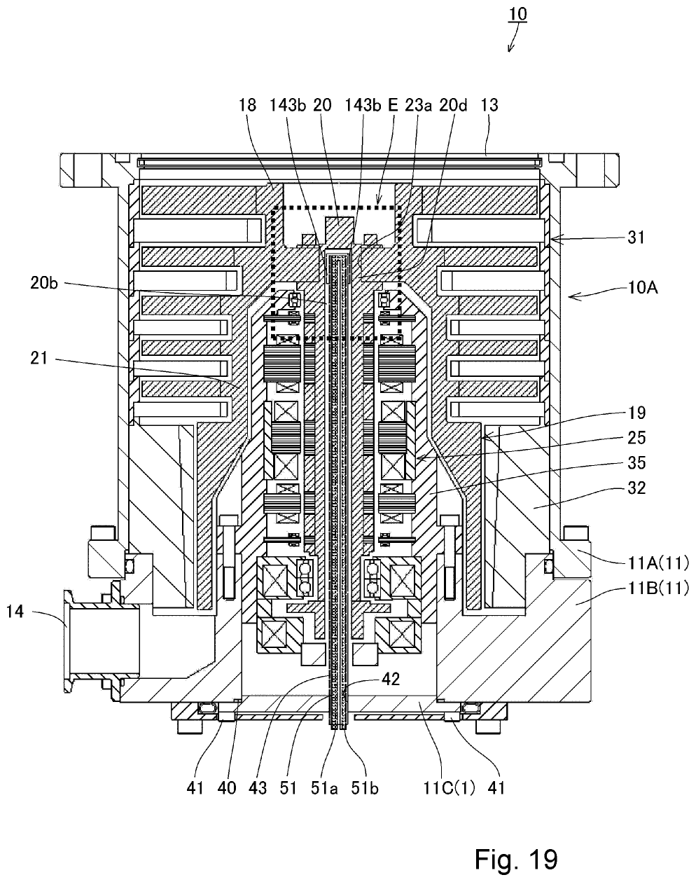

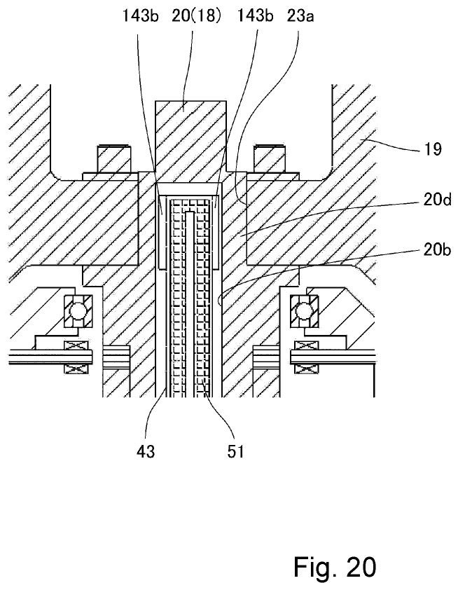

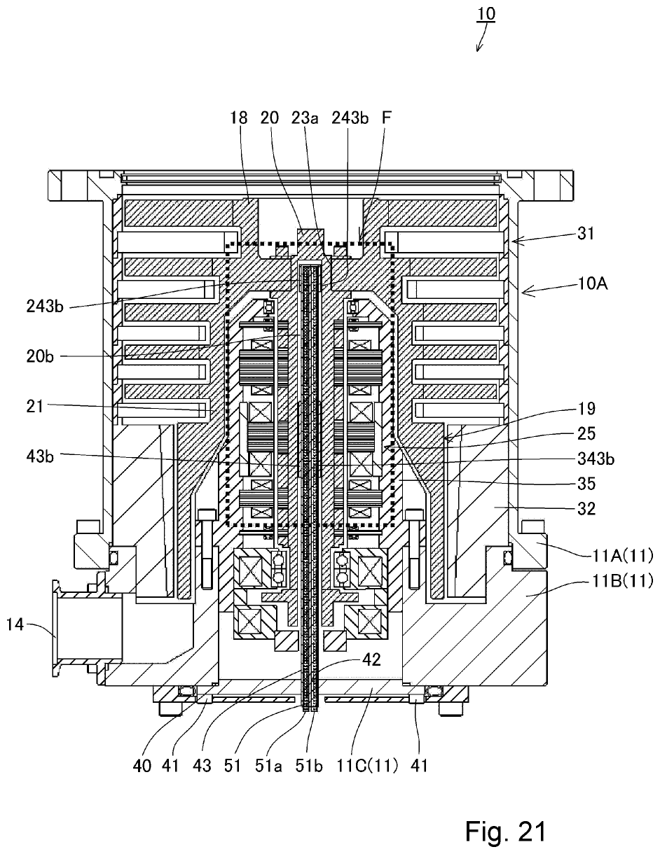

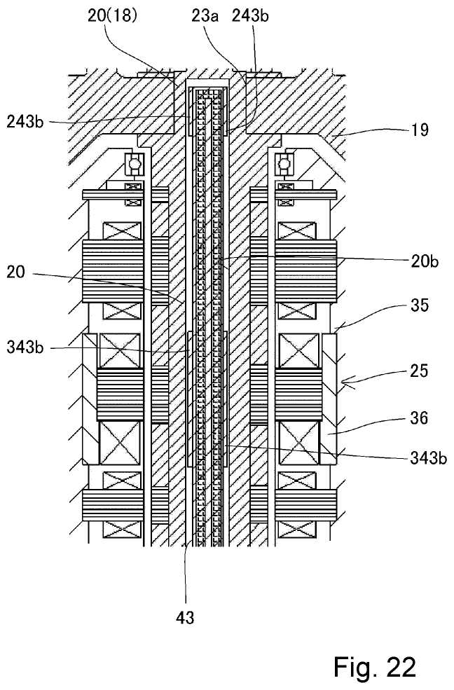

Moreover, in the vacuum pump 10 shown in FIG. 17 and FIG. 18, the fin 43b is provided on the outer peripheral surface of the cooling rod 43 corresponding to the motor portion 25, but it may be provided at a position corresponding to the rotor blade 19 as shown in FIG. 19 and FIG. 20 or at positions which can correspond to the motor portion 25 and the rotor blade 19, respectively, as shown in FIG. 21 and FIG. 22, for example. Note that, regarding the shape of the fin provided at each part, those with the same shape may be used or those with different shapes may be used at each part.

In more detail, FIG. 19 and FIG. 20 are diagrams illustrating still another variation of the vacuum pump 10 shown in FIG. 1, in which FIG. 19 is a schematic vertical-section side view of the vacuum pump 10 and FIG. 20 is an E-part enlarged view of FIG. 19. Note that the members in FIG. 19 and FIG. 20 given the same reference signs as in FIG. 1 are the same members as the members illustrated in FIG. 1, and duplicated explanation will be omitted.

In the vacuum pump 10 shown in FIG. 19 and FIG. 20, a fin 143b is provided on the outer peripheral surface on the upper end side of the cooling rod 43 so as to increase the surface area in the upper end portion of the cooling rod 43 so that the cooling effect in an upper end portion 20d of the rotating shaft 20 is improved as compared with the spot not corresponding to the fin 143b. Note that the fin 143b may be so constituted to be provided on the inner peripheral surface of the hollow part 20b.

FIG. 21 and FIG. 22 are diagrams illustrating still another variation of the vacuum pump 10 shown in FIG. 1, in which FIG. 21 is a schematic vertical-section side view of the vacuum pump 10, and FIG. 22 is an F-part enlarged view of FIG. 21.

Note that the members in FIG. 21 and FIG. 22 given the same reference signs as in FIG. 1 are the same members as the members illustrated in FIG. 1, and duplicated explanation will be omitted.

In the vacuum pump 10 shown in FIG. 21 and FIG. 22, fins 243b and 343b are provided at a spot on the outer peripheral surface of the cooling rod 43 corresponding to the rotor blade 19 and a spot on the outer peripheral surface of the cooling rod 43 corresponding to the motor portion 25, respectively. In this structure, the surface area of a spot corresponding to the rotor blade 19 of the cooling rod 43 is increased by the fin 243b, and the surface area of the spot corresponding to the motor portion 25 is increased by the fin 343b so that the cooling effect at the spots corresponding to the fins 243b, 343b, respectively, is improved as compared with the spot where the fins 243b, 343b are not provided.

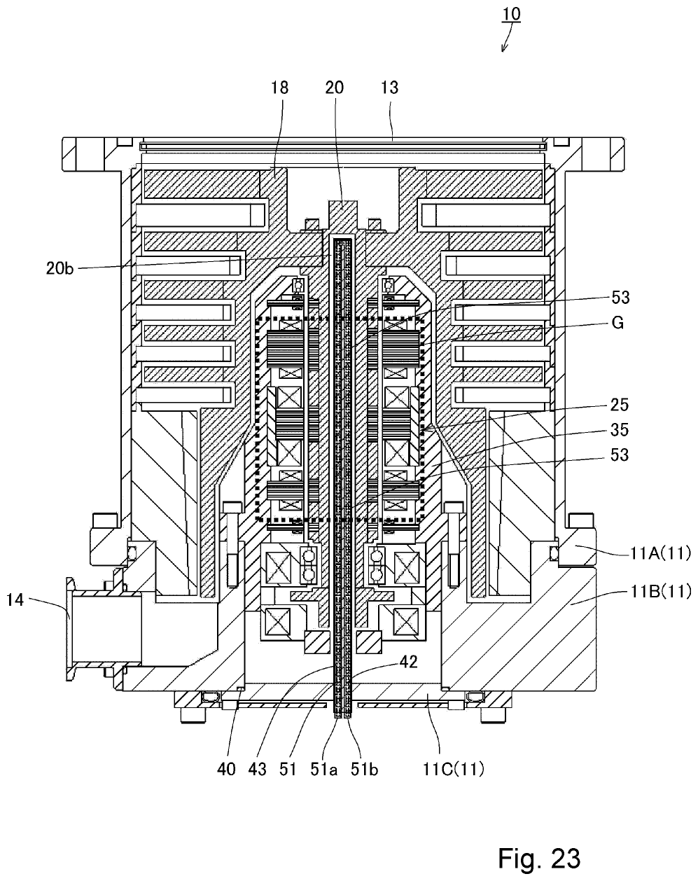

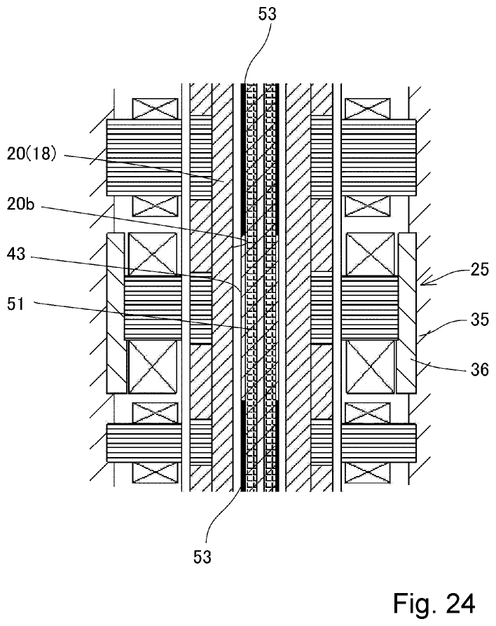

FIG. 23 and FIG. 24 are diagrams illustrating still another variation of the vacuum pump 10 shown in FIG. 1, in which FIG. 23 is a schematic vertical-section side view of the vacuum pump 10, and FIG. 24 is a G-part enlarged view of FIG. 23.

Note that the members in FIG. 23 and FIG. 24 given the same reference signs as in FIG. 1 are the same members as the members illustrated in FIG. 1, and duplicated explanation will be omitted.

In the vacuum pump 10 shown in FIG. 23 and FIG. 24, an insulating material 53 as a second insulating material is provided at a spot on the outer peripheral surface of the cooling rod 43 corresponding to the spot not requiring the cooling of the rotating body so as to peripherally cover the cooling rod 43. Moreover, as a material of the cooling rod 43 here, those with insulating characteristics are used, but heat conductivity of the cooling rod 43 is higher than the heat conductivity of the insulating material 53 so that the radiation heat from the rotating body 18 side is absorbed, and heat exchange can be performed with the refrigerant piping 51. In the vacuum pump 10 shown in FIG. 23 and FIG. 24, the spot corresponding to the motor portion 25 provided at the spot requiring the cooling is not covered by the insulating material 53, but the upper and lower spots not requiring the cooling is covered by the insulating material 53. Therefore, the cooling effect at the spot corresponding to the motor portion 25 not covered by the insulating material 53 is increased, the cooling effect at the spot corresponding to the motor portion 25 is improved as compared with the other spots. The insulating material 53 here includes a stainless alloy, ceramics, a synthetic resin, glass, glass wool and the like.

The spots requiring the cooling of the rotating body are some or all the spots such as heat generation portions and the like of the motor portion, the radial magnetic-bearing portion, the axial magnetic-bearing portion, the rotor blade portion and the like, for example. If the heat generation at the motor portion is larger than the heat generation of the radial magnetic-bearing portion and the axial magnetic bearing portion, for example, it is suitable that only the motor portion is cooled. Moreover, in the vacuum pump, the rotor blade is heated in order to prevent adhesion of products in some cases, but in such cases, it is suitable that the rotor blade is not cooled. The spots not requiring the cooling of the rotating body are spots of the rotating body other than the spots requiring the cooling of the rotating body.

Note that the present disclosure is capable of various alterations as long as they do not depart from the spirit of the present disclosure, and it is natural that the present disclosure includes those altered.

1. A rotating device comprising:
a casing; and
a rotating body having a rotating shaft disposed rotatably relative to the casing and constituted integrally with the rotating shaft,
the rotating device further comprising:
a hollow part formed along a center of the rotating shaft inside the rotating body; and
a cooling rod which is fixed to the casing and provided in the hollow part in a state of non-contact with the rotating body without having a mechanism for injecting a refrigerant into the hollow part, and which absorbs a radiation heat of the rotating body to cool the rotating body.

2. The rotating device according to claim 1, wherein:
the cooling rod is integrally connected to the casing through a first insulating material which shuts off the heat from the casing.

3. The rotating device according to claim 1, wherein:
the cooling rod has a heat radiation mechanism which radiates a heat of the cooling rod mounted on one end side withdrawn from the hollow part.

4. The rotating device according to claim 3, wherein:
the heat radiation mechanism has a heat radiation plate.

5. The rotating device according to claim 3, wherein:
the heat radiation mechanism incorporates piping through which cooling water is caused to flow.

6. The rotating device according to claim 3, wherein:
the heat radiation mechanism has a Peltier-type unit in which a Peltier element is provided.

7. The rotating device according to claim 1, wherein:
the cooling rod has a heat radiation portion disposed outside the hollow part and has a heat pipe disposed along the rotating shaft center in the hollow part.

8. The rotating device according to claim 7, wherein:
the heat pipes are provided in plural, and a high-temperature portion of at least one of the heat pipes is disposed by being shifted in a rotating-shaft direction.

9. The rotating device according to claim 7, wherein:
substantially entirety of the cooling rod is constituted by the heat pipe.

10. The rotating device according to claim 1, wherein:
the cooling rod is disposed along the rotating shaft center and has a refrigerant pipe through which a refrigerant is caused to flow, and the refrigerant pipe is disposed by being bent/reversed in the hollow part with both ends withdrawn to the outside of the hollow part.

11. The rotating device according to claim 1, wherein:
a purge gas is caused to flow through a gap between the cooling rod and the hollow part.

12. The rotating device according to claim 11, wherein:
the cooling rod includes a fin in contact with the purge gas on an outer peripheral surface.

13. The rotating device according to claim 11, wherein:
a groove through which the purge gas is passed is provided in an inner peripheral surface of the hollow part.

14. The rotating device according to claim 1, wherein
the cooling rod is formed with a locally increased thickness so that a surface area of a spot to be an outer peripheral surface or an inner peripheral surface of the cooling rod corresponding to a spot requiring cooling of the rotating body becomes larger than the surface area of a spot to be the outer peripheral surface or the inner peripheral surface of the cooling rod corresponding to a spot not requiring the cooling of the rotating body.

15. The rotating device according to claim 1, wherein:
a spot between the cooling rod and the hollow part corresponding to the spot not requiring the cooling of the rotating body is covered by a second insulating material.

16. A vacuum pump comprising:
a casing in which an inlet port and an outlet port are formed;
a rotating body having a rotating shaft disposed rotatably relative to the casing and constituted integrally with the rotating shaft,
the vacuum pump further comprising:
inside the rotating body, a hollow part formed along a center of the rotating shaft; and
a cooling rod which is fixed to the casing and provided in the hollow part in a state of non-contact with the rotating body without having a mechanism for injecting a refrigerant into the hollow part, and which absorbs a radiation heat of the rotating body to cool the rotating body.
